(19) United States
(12) Patent Application Publication
(10) Pub. No.: US 2026/0310195 A1
(43) Pub. Date: Oct. 8, 2026

(54) CONTROL SYSTEM, IN-VEHICLE COMMUNICATION DEVICE, AND CONTROL METHOD

(71) Applicant: TOYOTA JIDOSHA KABUSHIKI KAISHA, Toyota-shi (JP)

(72) Inventors: Yuki OKAMOTO, Ebina-shi (JP); Noritsugu Iwazaki, Sunto-gun (JP); Takeshi Kanou, Seto-shi (JP); Naufal Takbir Ibrahim, Numazu-shi (JP); Go Inoue, Gotenba-shi (JP); Sen Yang, Susono-shi (JP); Amane Yajima, Ashigarakami-gun (JP)

(73) Assignee: TOYOTA JIDOSHA KABUSHIKI KAISHA, Toyota-shi (JP)

(21) Appl. No.: 19/544,037

(22) Filed: Feb. 19, 2026

(30) Foreign Application Priority Data
Apr. 4, 2025 (JP) 2025-062315

(51) Int. Cl. G05D 1/226; B62D 65/18; G05D 107/70

(52) U.S. Cl. CPC G05D 1/226; B62D 65/18; G05D 2107/70

(57) ABSTRACT

A control system includes a server that transmits a traveling control signal for controlling driving of a vehicle at a regular cycle, an in-vehicle communication device that communicates with the server via wireless communication, the in-vehicle communication device including a storage unit that stores the traveling control signal received from the server in an overwritable manner until the traveling control signal is received from the server next time, and that transmits the traveling control signal stored in the storage unit at a regular cycle, and an in-vehicle control device that communicates with the in-vehicle communication device via wired communication, and that controls traveling of the vehicle using the traveling control signal received from the in-vehicle communication device.

### CROSS-REFERENCE TO RELATED APPLICATION

This application claims priority to Japanese Patent Application No. 2025-062315 filed on Apr. 4, 2025. The disclosure of the above-identified application, including the specification, drawings, and claims, is incorporated by reference herein in its entirety.

### BACKGROUND

### 1. Technical Field

The present disclosure relates to a control system, an in-vehicle communication device, and a control method.

### 2. Description of Related Art

Technology for causing vehicles to travel by remote control in a vehicle manufacturing plant is known (e.g., Japanese Unexamined Patent Application Publication No. 2017-538619 (JP 2017-538619 A)).

### SUMMARY

Even when a server transmits a traveling control signal for controlling a vehicle at regular cycles, delay in reception cycle of the traveling control signal by an in-vehicle communication device may occur, depending on a communication environment between the server and the in-vehicle communication device. As a result, there is a possibility that delay will occur in the transmission cycle of the traveling control signal from the in-vehicle communication device to the in-vehicle control device as well, resulting in deterioration in control performance of the vehicle. Accordingly, there is demand for technology that can suppress decrease in vehicle control performance due to delay occurring in the reception cycle of receiving the traveling control signal from the server.

The present disclosure can be realized in the following forms.

(1) According to a first aspect of the present disclosure, there is provided a control system. This control system includes a server that transmits a traveling control signal for controlling traveling of a vehicle at a regular cycle, an in-vehicle communication device that communicates with the server via wireless communication, the in-vehicle communication device including a storage unit that stores the traveling control signal received from the server in an overwritable manner until the traveling control signal is received from the server next time, and that transmits the traveling control signal stored in the storage unit at a regular cycle, and an in-vehicle control device that communicates with the in-vehicle communication device via wired communication, and that controls traveling of the vehicle using the traveling control signal received from the in-vehicle communication device.

According to the control system of this aspect, deterioration of control performance of the vehicle due to delay in the reception cycle of the traveling control signal that is received from the server can be suppressed.

(2) In the control system according to the above aspect, the in-vehicle communication device may determine whether a condition that is set in advance is satisfied, at a regular cycle, and when determining that the condition is satisfied, may overwrite the traveling control signal stored in the storage unit with another traveling control signal for controlling traveling of the vehicle.

According to the control system of this aspect, the traveling control signal stored in the storage unit can be overwritten with another traveling control signal, in accordance with whether the above condition is satisfied.

(3) In the control system according to the above aspect, a determination cycle of the condition by the in-vehicle communication device may be shorter than a transmission cycle of the traveling control signal by the server, and may also be shorter than a transmission cycle of the traveling control signal by the in-vehicle communication device.

According to the control system of this aspect, the traveling control signal stored in the storage unit can be quickly overwritten with another driving control signal.

(4) According to a second aspect of the present disclosure, there is provided an in-vehicle communication device. This in-vehicle communication device includes a receiving unit that receives a traveling control signal for controlling traveling of a vehicle, the traveling control signal being transmitted from a server via wireless communication at a regular cycle, a storage unit that stores the traveling control signal received from the server in an overwritable manner until the traveling control signal is received from the server next time, and a transmitting unit that transmits the traveling control signal stored in the storage unit at a regular cycle, via wired communication, to an in-vehicle control device that controls traveling of the vehicle in accordance with the traveling control signal.

According to the in-vehicle communication device of this aspect, deterioration of control performance of the vehicle due to delay in the reception cycle of the traveling control signal that is received from the server can be suppressed.

(5) According to a third aspect of the present disclosure, there is provided a control method. This control method includes receiving a traveling control signal that is transmitted from a server via wireless communication at a regular cycle, for controlling traveling of a vehicle, storing the traveling control signal received from the server in an overwritable manner until the traveling control signal is received from the server next time, and transmitting the traveling control signal that is stored at a regular cycle, via wired communication, to an in-vehicle control device that controls traveling of the vehicle in accordance with the traveling control signal.

According to the control method of this aspect, deterioration of control performance of the vehicle due to delay in the reception cycle of the traveling control signal that is received from the server can be suppressed.

The present disclosure may be realized in various forms other than a control system, an in-vehicle communication device, and a control method. For example, the present disclosure can be realized in the form of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram illustrating a configuration of a control system;

FIG. 2 is an explanatory diagram illustrating a configuration of a vehicle;

FIG. 3 is an explanatory diagram illustrating a configuration of a server;

FIG. 4 is a flowchart showing processing procedure for traveling control of a vehicle;

FIG. 5 is a flowchart showing procedures of transmission/reception processing by an in-vehicle communication device; and

FIG. 6 is an explanatory diagram showing a flow of traveling control signals in the control system.

### DETAILED DESCRIPTION OF EMBODIMENTS

### A. Embodiments:

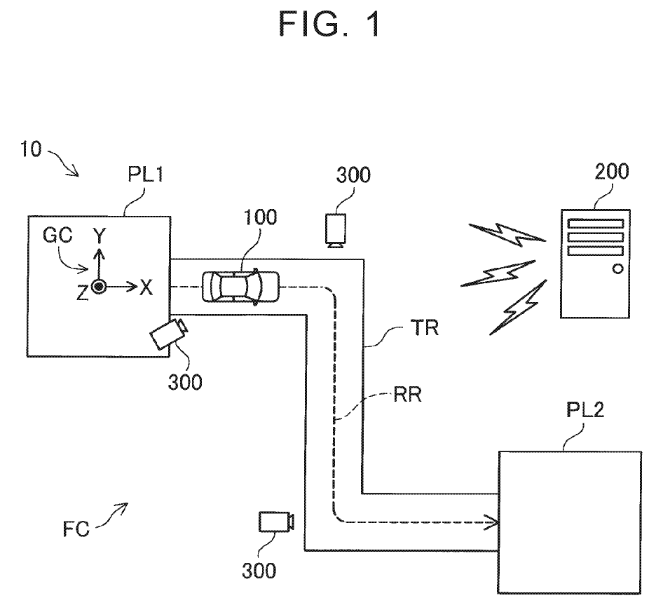

FIG. 1 is an explanatory diagram illustrating a configuration of a control system 10 according to an embodiment of the present disclosure. The control system 10 includes a vehicle 100 that is a moving body, a server 200 for remotely controlling the vehicle 100, and at least one external sensor 300 for acquiring position information of the vehicle 100.

In the present disclosure, the term "moving body" refers to an object that is capable of moving, such as, for example, a vehicle or an electric vertical take-off and landing aircraft (so-called flying car). The vehicle may be a vehicle that travels on wheels or a vehicle that travels on tracks, and may be, for example, a passenger car, a truck, a bus, a two-wheeled vehicle, a four-wheeled vehicle, a construction vehicle, or the like. Vehicles include battery electric vehicles (BEVs), gasoline-powered vehicles, hybrid electric vehicles, and fuel cell electric vehicles. When the moving body is other than a vehicle, the expressions "vehicle" and "car" in the present disclosure can be replaced with "moving body" as appropriate, and the expression "travel" can be replaced with "move" as appropriate.

The vehicle 100 is configured to be capable of traveling by unmanned driving. The term "unmanned driving" means driving without traveling operations being performed by an occupant. A traveling operation refers to an operation related to at least one of "traveling," "turning," and "stopping" of the vehicle 100. Unmanned driving is realized by automated or manual remote control using a device situated outside the vehicle 100, or by autonomous control of the vehicle 100. The vehicle 100 traveling by unmanned driving may have occupants that do not perform traveling operations on board. Occupants who do not perform traveling operations include, for example, people who are simply sitting in the seats of the vehicle 100, and people who are riding in the vehicle 100 and performing tasks other than traveling operations, such as assembly, inspection, or operating switches. Note that driving by traveling operations performed by an occupant is sometimes referred to as "manned driving."

In the present disclosure, the term "remote control" includes "full remote control" in which all of the operations of the vehicle 100 are completely decided from outside of the vehicle 100, and "partial remote control" in which part of the operations of the vehicle 100 are decided from outside of the vehicle 100. Also, "autonomous control" includes "fully autonomous control" in which the vehicle 100 autonomously controls its own operation without receiving any information from devices that are external with respect to the vehicle 100, and "partially autonomous control" in which the vehicle 100 autonomously controls its own operations using information received from devices that are external from the vehicle 100.

In the present embodiment, the control system 10 is used to cause the vehicle 100 to travel by remote control in a factory FC where the vehicle 100 is manufactured. The factory FC includes a first location PL1 and a second location PL2. The first location PL1 and the second location PL2 are connected by a track TR along which the vehicle 100 can travel.

In the factory FC, a plurality of the external sensors 300 is installed along the track TR. The external sensors 300 are sensors situated outside of the vehicle 100. The external sensors 300 are used to acquire vehicle position information, which is the position information of the vehicle 100. In the present embodiment, the external sensors 300 are cameras. The positions and orientations of the external sensors 300 in the factory FC are adjusted in advance. A reference coordinate system of the factory FC is a global coordinate system GC, and any position within the factory FC can be expressed by X, Y, and Z coordinates in the global coordinate system GC.

The first location PL1 is, for example, a location where assembly of the vehicle 100 is carried out. At the point of time of assembly at the first location PL1, the vehicle 100 is in a state of being capable of traveling by remote control. The vehicle 100 assembled at the first location PL1 moves from the first location PL1 along the track TR to the second location PL2 under remote control by the server 200. The second location PL2 is, for example, a location where inspection of the vehicle 100 is carried out. Vehicles 100 that pass the inspection at the second location PL2 are then shipped from the factory FC.

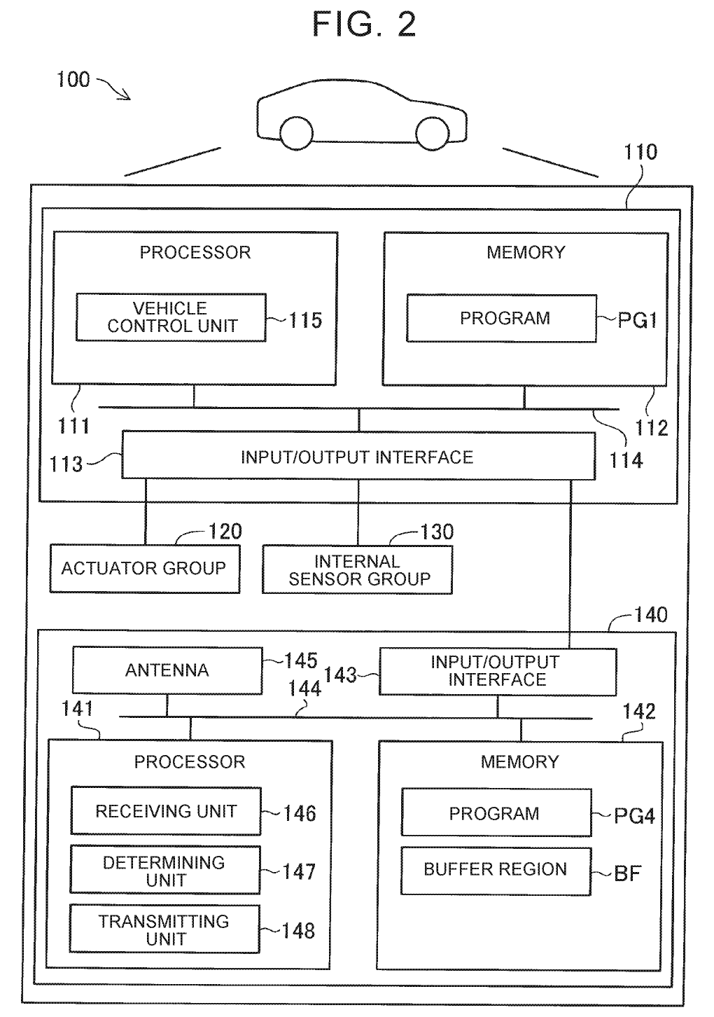

FIG. 2 is an explanatory diagram illustrating a configuration of the vehicle 100. In the present embodiment, the vehicle 100 is configured to be capable of travelling under remote control from the server 200. The vehicle 100 includes an in-vehicle control device 110, an actuator group 120, an internal sensor group 130, and an in-vehicle communication device 140. In the present embodiment, the vehicle 100 is configured such that the in-vehicle communication device 140 is detachably attachable.

The in-vehicle control device 110 controls each part of the vehicle 100. The in-vehicle control device 110 is made up of a computer. The in-vehicle control device 110 includes a processor 111, memory 112, an input/output interface 113, and an internal bus 114. The processor 111, the memory 112, and the input/output interface 113 are connected via the internal bus 114 so as to be capable of communicating bidirectionally. The input/output interface 113 is connected to the actuator group 120, the internal sensor group 130, and the in-vehicle communication device 140. The in-vehicle control device 110 communicates with the actuator group 120, the internal sensor group 130, and the in-vehicle communication device 140, via wired communication. CAN communication is used for the wired communication among the in-vehicle control device 110, the actuator group 120, the internal sensor group 130, and the in-vehicle communication device 140, for example.

The processor 111 of the in-vehicle control device 110 functions as a vehicle control unit 115 by executing a computer program PG1 that is stored in the memory 112 in advance. The vehicle control unit 115 controls the actuator group 120 using a traveling control signal received from the in-vehicle communication device 140 via wired communication. The traveling control signal is a control signal for controlling the traveling of the vehicle 100. The vehicle control unit 115 controls the traveling of the vehicle 100 in accordance with parameters included in the traveling control signal. In the present embodiment, the traveling control signal includes acceleration and steering angle as parameters. Note that in another embodiment, the traveling control signal may include speed as a parameter instead of acceleration, or in addition to acceleration.

The actuator group 120 includes at least one actuator. In the present embodiment, the actuator group 120 includes an actuator of a drive device that generates a propulsive force for the vehicle 100, an actuator of a steering device that changes direction of travel of the vehicle 100, and an actuator of a braking device that generates a braking force for the vehicle 100.

The internal sensor group 130 includes at least one internal sensor. The internal sensors are sensors installed in the vehicle 100. The internal sensor group 130 includes, for example, a vehicle speed sensor that detects the speed of the vehicle 100, a steering angle sensor that detects the steering angle of the vehicle 100, and obstruction sensors such as cameras and LiDAR devices, and so forth, that detect obstructions in the way of the vehicle 100.

The in-vehicle communication device 140 communicates with the server 200 via wireless communication. Wi-Fi communication, for example, is used for wireless communication between the server 200 and the in-vehicle communication device 140. The in-vehicle communication device 140 includes a processor 141, memory 142, an input/output interface 143, an internal bus 144, and an antenna 145. The processor 141, the memory 142, the input/output interface 143, and the antenna 145 are connected via the internal bus 144 so as to be capable of communicating bidirectionally. The memory 142 has a buffer region BF. Note that in the present disclosure, the buffer region BF of the memory 142 may be referred to as a "storage unit".

The processor 141 of the in-vehicle communication device 140 executes a computer program PG4 stored in advance in the memory 142, thereby functioning as a receiving unit 146, a determining unit 147, and a transmitting unit 148. The receiving unit 146 receives the traveling control signal from the server 200 via the antenna 145, and stores the traveling control signal that is received in the buffer region BF of the memory 142. The buffer region BF stores the traveling control signal in an overwritable manner. The traveling control signal is transmitted from the server 200 to the in-vehicle communication device 140 at regular cycles. After storing the traveling control signal received from the server 200 in the buffer region BF, and then receiving a new traveling control signal from the server 200, the receiving unit 146 overwrites the traveling control signal stored in the buffer region BF with the traveling control signal that is newly received from the server 200.

The determining unit 147 determines whether a condition that has been set in advance is satisfied, at regular cycles. In the present embodiment, a determination cycle of the determining unit 147 determining the above condition is shorter than a transmission cycle of the traveling control signal by the server 200, and is also shorter than the transmission cycle of the traveling control signal by the transmitting unit 148. In the present embodiment, the above condition is that a driving permission condition, which will be described later, is no longer satisfied. When determining that the driving permission condition is no longer satisfied, the determining unit 147 overwrites the traveling control signal stored in the buffer region BF of the memory 142 with another traveling control signal. When determining that the driving permission condition is satisfied, the determining unit 147 does not overwrite the traveling control signal stored in the buffer region BF with another traveling control signal. In the present embodiment, the other traveling control signal is a traveling control signal for bringing the vehicle 100 to an emergency stop.

The transmitting unit 148 transmits the traveling control signal stored in the buffer region BF of the memory 142 to the in-vehicle control device 110 at regular cycles. When the traveling control signal stored in the buffer region BF is not overwritten by the determining unit 147, the traveling control signal received by the receiving unit 146 is transmitted to the in-vehicle control device 110. In contrast, when the determining unit 147 executes overwriting of the traveling control signal stored in the buffer region BF, the traveling control signal that is overwritten by the determining unit 147 is transmitted to the in-vehicle control device 110, rather than the traveling control signal received by the receiving unit 146.

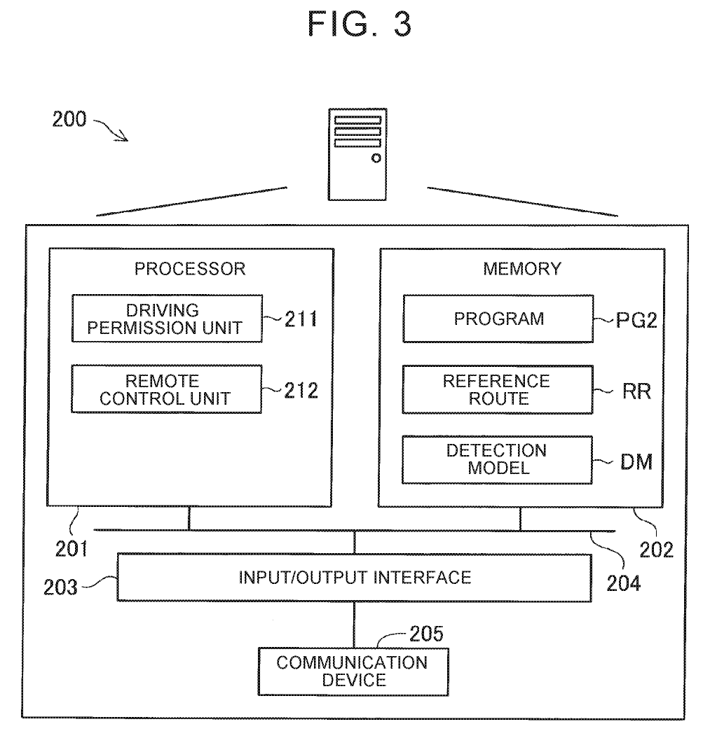

FIG. 3 is an explanatory diagram illustrating a configuration of the server 200. The server 200 is situated outside of the vehicle 100. The server 200 is made up of a computer. The server 200 includes a processor 201, a memory 202, an input/output interface 203, and an internal bus 204. The processor 201, the memory 202, and the input/output interface 203 are connected via the internal bus 204 so as to be capable of communicating bidirectionally. The server 200 further includes a communication device 205 for communicating externally. The communication device 205 is connected to the input/output interface 203. In the present embodiment, the communication device 205 communicates with the in-vehicle communication device 140 via wireless communication, and communicates with the external sensors 300 via wired communication or wireless communication.

The processor 201 executes a computer program PG2, stored in the memory 202 in advance, to function as a driving permission unit 211 and a remote control unit 212. The driving permission unit 211 transmits a driving permission condition to the in-vehicle communication device 140 prior to traveling of the vehicle 100 by remote control. In the present embodiment, the driving permission condition includes a window period, a maximum vehicle speed, and a maximum steering angle, as parameters. The window period is an upper limit value of time from when the in-vehicle communication device 140 receives a traveling control signal from the server 200 until receiving the next traveling control signal from the server 200. The maximum vehicle speed is an upper limit value of the vehicle speed of the vehicle 100. The maximum steering angle is an upper limit value of the steering angle of the vehicle 100. The remote control unit 212 causes the vehicle 100 to travel by remote control. In the present embodiment, the remote control unit 212 acquires vehicle position information indicating the position of the vehicle 100 using the external sensors 300, generates a traveling control signal using the vehicle position information that is acquired, and transmits the traveling control signal that is generated to the in-vehicle communication device 140.

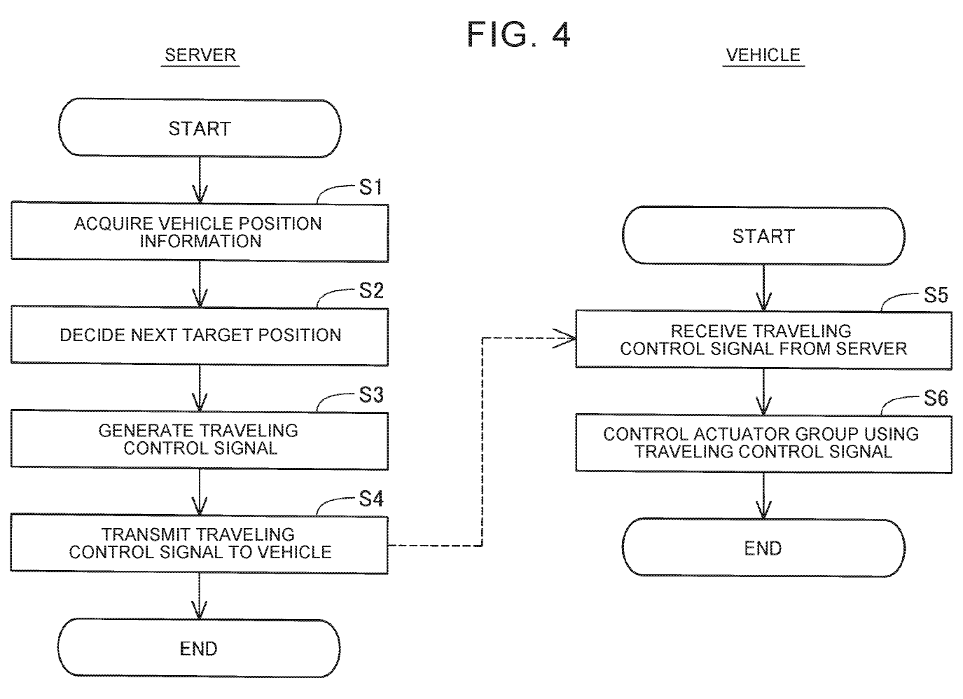

FIG. 4 is a flowchart showing processing procedures for traveling control of the vehicle 100. In step S1, the server 200 acquires vehicle position information using a detection result output from the external sensors 300, which are sensors situated outside of the vehicle 100. The vehicle position information is position information that serves as a basis for generating the traveling control signals. In the present embodiment, the vehicle position information includes the position and the orientation of the vehicle 100 in the reference coordinate system of the factory FC. In the present embodiment, the reference coordinate system of the factory FC is the global coordinate system GC, and any position within the factory FC can be expressed by X, Y, and Z coordinates in the global coordinate system GC. In the present embodiment, the external sensors 300 are cameras installed in the factory FC, and the external sensors 300 output captured images as detection results. That is to say, in step S1, the server 200 acquires the vehicle position information using captured images acquired by the cameras, which are the external sensors 300.

Specifically, in step S1, the server 200 detects an external profile of the vehicle 100 from the captured images, calculates the coordinates of the point of positioning of the vehicle 100 in the coordinate system of the captured images, i.e., a local coordinate system, and converts the calculated coordinates into coordinates in the global coordinate system GC, thereby acquiring the position of the vehicle 100. The external profile of the vehicle 100 included in the captured images can be detected, for example, by inputting the captured images into the detection model DM that utilizes artificial intelligence. The detection model DM is prepared inside the control system 10 or outside of the control system 10, for example, and is stored in advance in the memory 202 of the server 200. Examples of the detection model DM include a trained machine learning model that has been trained to realize either semantic segmentation or instance segmentation. A convolutional neural network (hereinafter referred to as "CNN") trained by supervised learning using a training dataset, for example, can be used as this machine learning model. The learning dataset contains, for example, a plurality of training images including the vehicle 100, and labels indicating whether each region in the training images is a region that represents the vehicle 100 or is a region other than the vehicle 100. During CNN training, it is preferable to update the CNN parameters by backpropagation (error backpropagation) so as to reduce error between output results of the detection model DM and the labels. Also, the server 200 can acquire the orientation of the vehicle 100 by, for example, using optical flow positioning to estimate the orientation, based on the orientation of a movement vector of the vehicle 100 that is calculated from the positional changes of the feature points of the vehicle 100 among frames of the captured images.

In step S2, the server 200 decides a target position to which the vehicle 100 should head next. In the present embodiment, the target position is expressed by X, Y, and Z coordinates in the global coordinate system GC. The memory 202 of the server 200 stores, in advance, a reference route RR, which is a route along which the vehicle 100 should travel. The route is represented by a node indicating a starting point, a node indicating a waypoint, a node indicating a destination, and links connecting the nodes. The server 200 uses the vehicle position information and the reference route RR to decide the next target position to which the vehicle 100 should head. The server 200 decides a target position on the reference route RR ahead of the current position of the vehicle 100.

In step S3, the server 200 generates a traveling control signal for causing the vehicle 100 to travel toward the target position that is decided. In the present embodiment, the traveling control signal includes the acceleration and the steering angle of the vehicle 100 as parameters. The server 200 calculates the traveling speed of the vehicle 100 from the transition in the position of the vehicle 100, and compares the traveling speed that is calculated with a target speed. Overall, the server 200 decides the acceleration such that the vehicle 100 accelerates when the traveling speed is lower than the target speed, and decides the acceleration such that the vehicle 100 decelerates when the traveling speed is higher than the target speed. Also, when the vehicle 100 is situated on the reference route RR, the server 200 decides the steering angle and the acceleration such that the vehicle 100 does not depart from the reference route RR, and when the vehicle 100 is not situated on the reference route RR, i.e., when the vehicle 100 has departed from the reference route RR, the server decides the steering angle and the acceleration such that the vehicle 100 returns to the reference route RR. In another embodiment, the traveling control signal may include the speed of the vehicle 100 as a parameter instead of or in addition to the acceleration of the vehicle 100.

In step S4, the server 200 transmits the traveling control signal that is generated to the vehicle 100. The server 200 repeats, at a predetermined cycle, acquiring of the vehicle position information, deciding of the target position, generating of the traveling control signal, transmitting of the traveling control signal, and so forth.

In step S5, the vehicle 100 receives the traveling control signal transmitted from the server 200. In step S6, the vehicle 100 controls the actuators of the vehicle 100 using the traveling control signal that is received, thereby causing the vehicle 100 to travel in accordance with the acceleration and the steering angle indicated in the traveling control signal. The vehicle 100 repeats the receiving of the traveling control signal and the controls of the actuators of the vehicle 100, at a predetermined cycle. According to the control system 10 of the present embodiment, the vehicle 100 can be made to travel by remote control, and the vehicle 100 can be moved without using transport equipment such as a crane, a conveyor, or the like.

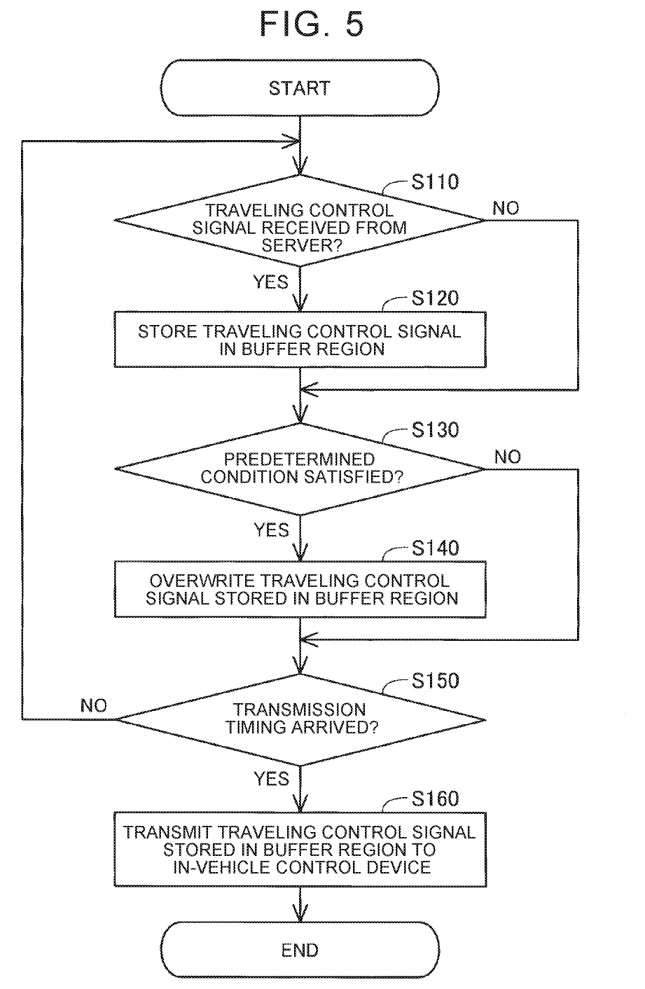

FIG. 5 is a flowchart showing procedures of transmission/reception processing of the traveling control signal by the in-vehicle communication device 140. The transmission/reception processing is repeatedly executed at a predetermined cycle by the processor 141 of the in-vehicle communication device 140. When the transmission/reception processing is started, in step S110, the receiving unit 146 determines whether a traveling control signal has been received from the server 200. When determination is made in step S110 that a traveling control signal has been received from the server 200, the receiving unit 146 stores the traveling control signal that is received in the buffer region BF of the memory 142 in step S120. When determination is made in step S110 that no traveling control signal has been received, the receiving unit 146 skips step S120 and advances the processing to step S130.

In step S130, the determining unit 147 determines whether a condition that is set in advance has been satisfied. In the present embodiment, the above condition is that the driving permission condition is no longer satisfied. The driving permission condition contains the following condition A, condition B, and condition C.

### Condition A

This condition is that elapsed time, which is the amount of time that has elapsed since the receiving unit 146 most recently received a traveling control signal, is within a window period, which is the upper limit value of the elapsed time.

### Condition B

This condition is that the vehicle speed of the vehicle 100 is within the maximum vehicle speed, which is the upper limit value of this vehicle speed.

### Condition C

This condition is that the steering angle of the vehicle 100 is within the maximum steering angle, which is the upper limit value of this steering angle.

When all of the conditions A, B, and C are satisfied, the determining unit 147 determines that the driving permission condition is satisfied. When at least one of the conditions A, B, and C is not satisfied, determination is made that the driving permission condition is no longer satisfied. Regarding condition A, the window period is set to an amount of time that is longer than the transmission cycle of the traveling control signal from the server 200. The determining unit 147 counts the elapsed time. Regarding condition B, the determining unit 147 can acquire the vehicle speed of the vehicle 100 using a vehicle speed sensor included in the internal sensor group 130. Regarding condition C, the determining unit 147 can acquire the steering angle of the vehicle 100 using a steering angle sensor included in the internal sensor group 130.

When determination is made in step S130 that the condition that is set in advance is satisfied, i.e., when determination is made that the driving permission condition is no longer satisfied, the determining unit 147 overwrites the traveling control signal stored in the buffer region BF with another traveling control signal in step S140. In the present embodiment, the other traveling control signal is a traveling control signal for bringing the vehicle 100 to an emergency stop. When determination is made in step S130 that the condition that is set in advance is not satisfied, i.e., when determination is made that the driving permission condition is satisfied, the determining unit 147 skips step S140 and advances the processing to step S150. Note that when the driving permission condition is no longer satisfied, the possibility of the vehicle 100 coming into contact with an obstruction increases. Accordingly, determining whether the driving permission condition is no longer satisfied can be rephrased as determining whether there is a possibility that the vehicle 100 will come into contact with an obstruction.

In step S150, the transmitting unit 148 determines whether the timing for transmitting a traveling control signal to the in-vehicle control device 110 has arrived. When determination is made in step S150 that the timing for transmitting the traveling control signal to the in-vehicle control device 110 has not arrived, the transmitting unit 148 returns the processing to step S110. When determination is made in step S150 that the timing for transmitting the traveling control signal to the in-vehicle control device 110 has arrived, the transmitting unit 148 transmits the traveling control signal stored in the buffer region BF to the vehicle control device 110 in step S160. Thereafter, the processor 141 ends the transmission/reception processing. The processor 141 repeats the transmission/reception processing at a predetermined cycle.

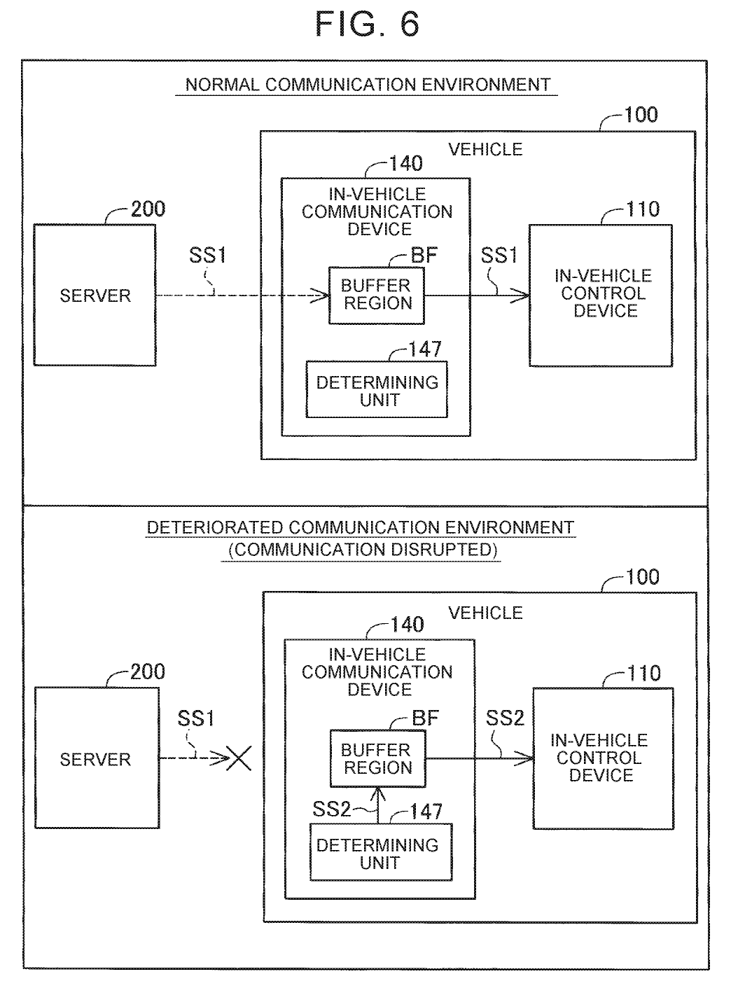

FIG. 6 is an explanatory diagram showing a flow of traveling control signals SS1 and SS2 in the control system 10. As shown in the upper part of FIG. 6, the server 200 transmits the traveling control signal SS1 to the in-vehicle communication device 140 via wireless communication at regular cycles. In the present embodiment, the server 200 transmits the traveling control signal SS1 at cycles of 100 milliseconds. The in-vehicle communication device 140 receives the traveling control signal SS1 transmitted from the server 200. When a communication environment between the server 200 and the in-vehicle communication device 140 is normal, a reception cycle of the traveling control signal SS1 by the in-vehicle communication device 140 is the same as the transmission cycle of the traveling control signal SS1 by the server 200. The in-vehicle communication device 140 stores the traveling control signal SS1 received from the server 200 in the buffer region BF of the memory 142 in an overwritable manner.

The determining unit 147 of the in-vehicle communication device 140 determines whether the driving permission condition is no longer satisfied at regular cycles. In the present embodiment, the determining unit 147 determines whether the driving permission condition is no longer satisfied at cycles of 20 milliseconds. The driving permission condition includes that the elapsed time, which is the time that has elapsed since the in-vehicle communication device 140 most recently received the traveling control signal SS1, does not exceed the window period, which is the upper limit value of this elapsed time (condition A).

As shown in the upper part of FIG. 6, when the communication environment between the server 200 and the in-vehicle communication device 140 is normal, the reception cycle of the traveling control signal SS1 by the in-vehicle communication device 140 will be the same as the transmission cycle of the traveling control signal SS1 by the server 200, and accordingly the elapsed time will not exceed the window period. When determining that the driving permission condition is satisfied, the determining unit 147 does not overwrite the traveling control signal SS1 stored in the buffer region BF.

As shown in the lower part of FIG. 6, when the communication environment between the server 200 and the in-vehicle communication device 140 deteriorates, and communication between the server 200 and the in-vehicle communication device 140 is disrupted, for example, the elapsed time will exceed the window period. When the elapsed time exceeds the window period, the determining unit 147 determines that the driving permission condition is no longer satisfied. When determining that the driving permission condition is no longer satisfied, the determining unit 147 immediately overwrites the traveling control signal SS1 stored in the buffer region BF with the traveling control signal SS2 for bringing the vehicle 100 to an emergency stop.

As shown in the upper part and lower part of FIG. 6, the in-vehicle communication device 140 transmits the traveling control signal SS1 or the traveling control signal SS2 stored in the buffer region BF to the in-vehicle control device 110 via wired communication at regular cycles. In the present embodiment, the in-vehicle communication device 140 transmits the traveling control signal SS1 or the traveling control signal SS2 at cycles of 100 milliseconds. The in-vehicle control device 110 receives the traveling control signal SS1 or the traveling control signal SS2 transmitted from the in-vehicle communication device 140, and controls the actuator group 120 using the traveling control signal SS1 or the traveling control signal SS2 that is received.

Now, in another form, which is an event-driven form in which the in-vehicle communication device 140 transmits the traveling control signal SS1 that is received to the vehicle control device 110 as soon as an event occurs in which the traveling control signal SS1 is received from the server 200, when the communication environment between the server 200 and the in-vehicle communication device 140 deteriorates and a delay occurs in the reception cycle of the traveling control signal SS1 by the in-vehicle communication device 140, a delay will also occur in the transmission cycle of the traveling control signal SS1 from the in-vehicle communication device 140 to the vehicle control device 110. The in-vehicle control device 110 preferably controls the actuator group 120 using the latest traveling control signal SS1. However, in the above-described other form, unless an event occurs in which the traveling control signal SS1 is received from the server 200, the latest traveling control signal SS1 is not transmitted from the in-vehicle communication device 140 to the in-vehicle control device 110. As a result, the in-vehicle control device 110 will control the actuator group 120 using an old traveling control signal SS1 until receiving the latest traveling control signal SS1 from the in-vehicle communication device 140, which will degrade the control performance of the vehicle 100. In addition, in the other form described above, even when the determining unit 147 determines that the driving permission condition is no longer satisfied, the traveling control signal SS2 for bringing the vehicle 100 to an emergency stop is not transmitted from the in-vehicle communication device 140 to the in-vehicle control device 110 unless an event occurs in which the traveling control signal SS1 is received from the server 200. As a result, the in-vehicle control device 110 will control the actuator group 120 using the old traveling control signal SS1 until receiving the latest traveling control signal SS2 from the in-vehicle communication device 140, and an emergency stop of the vehicle 100 will not be performed, resulting in a decrease in the control performance of the vehicle 100.

According to the control system 10 of the present embodiment described above, the in-vehicle communication device 140 stores the traveling control signal SS1 received from the server 200 in the buffer region BF of the memory 142 in an overwritable manner until the next traveling control signal SS1 is received. When the driving permission condition is no longer satisfied, the in-vehicle communication device 140 overwrites the traveling control signal SS1 stored in the buffer region BF with the traveling control signal SS2 for bringing the vehicle 100 to an emergency stop. The in-vehicle communication device 140 transmits the traveling control signal SS1 or the traveling control signal SS2 stored in the buffer region BF to the in-vehicle control device 110 at regular cycles. Accordingly, even when a delay occurs in the reception cycle of the traveling control signal SS1 by the in-vehicle communication device 140, no delay occurs in the reception cycle of the traveling control signals SS1, SS2 by the in-vehicle control device 110. Thus, degradation of the control performance of the vehicle 100 due to a delay in the reception cycle of the traveling control signal SS1 by the in-vehicle communication device 140 can be suppressed from occurring.

Also, in the present embodiment, when the driving permission condition is no longer satisfied, the determining unit 147 of the in-vehicle communication device 140 overwrites the traveling control signal SS1 stored in the buffer region BF with the traveling control signal SS2 for bringing the vehicle 100 to an emergency stop. The in-vehicle communication device 140 transmits the traveling control signal SS2 stored in the buffer region BF to the in-vehicle control device 110 at regular cycles. Accordingly, even when there is a delay in the reception cycle of the traveling control signal SS1 by the in-vehicle communication device 140 occurring, the vehicle control device 110 can bring the vehicle 100 to an emergency stop by performing traveling control using the traveling control signal SS2. Thus, the vehicle 100 can be suppressed from coming into contact with an obstruction due to continuation of traveling control using the old traveling control signal SS1.

Also, in the present embodiment, the determination cycle by the determining unit 147 of the in-vehicle communication device 140 is shorter than the transmission cycle of the traveling control signal SS1 by the server 200, and is also shorter than the transmission cycle of the traveling control signals SS1, SS2 by the in-vehicle communication device 140. Accordingly, when the driving permission condition is no longer satisfied, the determining unit 147 can immediately overwrite the traveling control signal SS1 stored in the buffer region BF with the traveling control signal SS2 for bringing the vehicle 100 to an emergency stop.

### B. Other Embodiments

(B1) In the above embodiment, when determining that the driving permission condition is no longer satisfied, the determining unit 147 of the in-vehicle communication device 140 overwrites the traveling control signal SS1 stored in the buffer region BF of the memory 142 with the traveling control signal SS2 for bringing the vehicle 100 to an emergency stop. In contrast to this, the determining unit 147 may determine whether overwriting the traveling control signal SS1 stored in the buffer region BF is necessary, based on conditions other than the driving permission condition.

(B2) In the above embodiment, the determination cycle regarding the driving permission condition by the determining unit 147 of the in-vehicle communication device 140 is shorter than the transmission period of the traveling control signal SS1 by the server 200, and is also shorter than the transmission cycle of the traveling control signal SS1 or the traveling control signal SS2 by the in-vehicle communication device 140. On the other hand, the determination cycle regarding the driving permission condition by the determining unit 147 may be the same as or longer than the transmission cycle of the traveling control signal SS1 by the server 200. The determination cycle relating to the driving permission condition by the determining unit 147 may be the same as or longer than the transmission cycle of the traveling control signal SS1 or the traveling control signal SS2 by the in-vehicle communication device 140.

(B3) In the above embodiment, the external sensors 300 are not limited to cameras, and may be, for example, ranging devices. The ranging device is, for example, a LiDAR (Light Detection and Ranging) device. In this case, detection results output by the external sensors 300 may be three-dimensional point cloud data representing the vehicle 100. In this case, the server 200 and the vehicle 100 may acquire the vehicle position information by template matching, using the three-dimensional point cloud data as the detection results, and reference point cloud data prepared in advance.

(B4) In the above embodiment, the server 200 executes the processing from acquiring the vehicle position information to generating the traveling control signal. Alternatively, at least part of the processing from acquiring the vehicle position information to generating the traveling control signal may be executed by the vehicle 100. For example, the following forms (1) to (3) may be carried out.
(1) The server 200 may acquire vehicle position information, decide a target position to which the vehicle 100 should head next, and generate a route from the current location of the vehicle 100 indicated in the vehicle position information that is acquired to the target position. The server 200 may generate a route to a target position between the current location and the destination, or generate a route to the destination. The server 200 may transmit the generated route to the vehicle 100. The vehicle 100 may generate a traveling control signal such that the vehicle 100 travels on the route received from the server 200, and control the actuator group 120 of the vehicle 100 using the traveling control signal that is generated.
(2) The server 200 may acquire vehicle position information and transmit the vehicle position information that is acquired to the vehicle 100. The vehicle 100 may decide a target position to which the vehicle 100 should head next, generate a route from the current location of the vehicle 100 represented in the vehicle position information that is received to the target position, generate a traveling control signal such that the vehicle 100 travels over the route that is generated, and control the actuator group 120 of the vehicle 100 using the traveling control signal that is generated.
(3) In the above forms (1), (2), an internal sensor may be installed in the vehicle 100, and detection results output from the internal sensor may be used for at least one of generating the route and generating the traveling control signal. The internal sensor is a sensor installed in the vehicle 100. Specifically, the internal sensor can include, for example, a camera, a LiDAR device, a millimeter-wave radar device, an ultrasonic sensor, a Global Positioning System (GPS) sensor, an acceleration sensor, a gyro sensor, or the like. For example, in the above form (1), the server 200 may acquire the detection results of the internal sensor, and when generating a route, the detection results of the internal sensor may be reflected in the route. In the above form (1), the vehicle 100 may acquire the detection results of the internal sensor, and when generating the traveling control signal, may reflect the detection result of the internal sensor in the traveling control signal. In the above form (2), the vehicle 100 may acquire the detection results of the internal sensor, and may reflect the detection results of the internal sensor in the route when generating the route. In the above form (2), the vehicle 100 may acquire the detection results of the internal sensor, and when generating the traveling control signal, may reflect the detection results of the internal sensor in the traveling control signal.

(B5) In the above embodiment, the server 200 automatically generates the traveling control signal to be transmitted to the vehicle 100. Alternatively, the server 200 may generate a traveling control signal to be transmitted to the vehicle 100 in accordance with operation of an external operator situated outside of the vehicle 100. For example, an external operator may operate a maneuvering device that includes a display displaying captured images output from the external sensors 300, a steering wheel for remotely operating the vehicle 100, an accelerator pedal, a brake pedal, and a communication device for communicating with the server 200 via wired communication or wireless communication, and the server 200 may generate a traveling control signal in accordance with the operations performed on the maneuvering device.

(B6) In the above embodiment, it is sufficient for the vehicle 100 to be provided with a configuration so as to be capable of moving by unmanned driving, and may be in the form of a platform having the configuration described below, for example. Specifically, in order for the vehicle 100 to manifest the three functions of "travelling," "turning," and "stopping" through unmanned driving, it is sufficient for the vehicle 100 to be equipped with at least a control device that controls traveling thereof, and actuators such as a drive device, a steering device, and a braking device. In the case in which the vehicle 100 externally acquires information for unmanned driving, it is sufficient for the vehicle 100 to further include a communication device. That is to say, the vehicle 100 that can move by unmanned driving does not have to be equipped with at least some of the interior parts, such as a driver's seat, dashboard, and so forth, does not have to be equipped with at least some exterior parts such as bumpers, fenders, and so forth, and does not have to be equipped with a body shell. In this case, the remaining parts such as the body shell and so forth may be attached to the vehicle 100 before the vehicle 100 is shipped from the factory FC, or the remaining parts such as the body shell and so forth may be attached to the vehicle 100 after the vehicle 100 is shipped from the factory FC in a state without the remaining parts such as the body shell and so forth attached to the vehicle 100. Each part may be attached from any direction, such as the upper side, lower side, front side, rear side, right side, or left side of the vehicle 100, and may each be attached from the same direction and may each be attached from different directions. Note that in the form regarding the platform as well, the position can be decided in the same way as with the vehicle 100 in the embodiment.

(B7) The vehicle 100 may be manufactured by combining a plurality of modules. The term module refers to a unit made up of one or more parts grouped together in accordance with the configuration and the function of the vehicle 100. For example, the platform of the vehicle 100 may be manufactured by combining a front module that makes up a front part of the platform, a middle module that makes up a middle part of the platform, and a rear module that makes up a rear part of the platform. Note that the number of modules making up the platform is not limited to three, and may be two or less, or four or more. Also, in addition to or instead of the platform, portions of the vehicle 100 that are different from the platform may be modularized. The various types of modules may also include any exterior parts such as bumpers and grilles, or any interior parts such as seats and consoles. Also, the present disclosure is not limited to the vehicle 100, and any form of moving body may be manufactured by combining multiple modules. Such modules may be manufactured by joining multiple parts together by welding or using fasteners or the like, or by integrally molding at least a portion of the module as a single part by casting, for example. A molding technique of integrally molding at least a part of the module as a single component is also referred to as "gigacasting" or "megacasting". Using gigacasting enables each part of a moving body that was conventionally formed by joining multiple parts to be formed as a single part. For example, the front module, the middle module, and the rear module may be manufactured using gigacasting.

(B8) Transporting the vehicle 100 by using traveling by the unmanned driving of the vehicle 100 is also referred to as "self-propelled transport". The configuration for realizing self-propelled transport is also referred to as "vehicle remote-controlled autonomous transport system". Also, a production method in which the vehicle 100 is produced using self-propelled transport is also referred to as "self-propelled production". In self-propelled production, at the factory FC where the vehicle 100 is manufactured, at least part of transporting of the vehicle 100 is realized by self-propelled transport.

The present disclosure is not limited to the above-described embodiments, and can be realized in various configurations without departing from the spirit thereof. For example, the technical features in the embodiment that correspond to the technical features in each aspect described in the Summary of the Disclosure section can be substituted or combined as appropriate, in order to solve some or all of the above problems or to achieve some or all of the above-mentioned effects. Also, any technical feature that is not described as being essential in the present specification can be deleted as appropriate.

What is claimed is:

1. A control system comprising:
a server that transmits a traveling control signal for controlling traveling of a vehicle at a regular cycle;
an in-vehicle communication device that communicates with the server via wireless communication, the in-vehicle communication device including a storage unit that stores the traveling control signal received from the server in an overwritable manner until the traveling control signal is received from the server next time, and that transmits the traveling control signal stored in the storage unit at a regular cycle; and
an in-vehicle control device that communicates with the in-vehicle communication device via wired communication, and that controls traveling of the vehicle using the traveling control signal received from the in-vehicle communication device.

2. The control system according to claim 1, wherein the in-vehicle communication device determines whether a condition that is set in advance is satisfied, at a regular cycle, and when determining that the condition is satisfied, overwrites the traveling control signal stored in the storage unit with another traveling control signal for controlling traveling of the vehicle.

3. The control system according to claim 2, wherein a determination cycle of the condition by the in-vehicle communication device is shorter than a transmission cycle of the traveling control signal by the server, and is also shorter than a transmission cycle of the traveling control signal by the in-vehicle communication device.

4. An in-vehicle communication device comprising:
a receiving unit that receives a traveling control signal for controlling traveling of a vehicle, the traveling control signal being transmitted from a server via wireless communication at a regular cycle;
a storage unit that stores the traveling control signal received from the server in an overwritable manner until the traveling control signal is received from the server next time; and
a transmitting unit that transmits the traveling control signal stored in the storage unit at a regular cycle, via wired communication, to an in-vehicle control device that controls traveling of the vehicle in accordance with the traveling control signal.

5. A control method comprising:
receiving a traveling control signal that is transmitted from a server via wireless communication at a regular cycle, for controlling traveling of a vehicle;
storing the traveling control signal received from the server in an overwritable manner until the traveling control signal is received from the server next time; and
transmitting the traveling control signal that is stored at a regular cycle, via wired communication, to an in-vehicle control device that controls traveling of the vehicle in accordance with the traveling control signal.
